(19) United States
(12) Patent Application Publication
(10) Pub. No.: US 2024/0088595 A1
(43) Pub. Date: Mar. 14, 2024

(54) FASTENING STRUCTURE OF METAL PLATES, DEVICE CONNECTOR INCLUDING FASTENING STRUCTURE OF METAL PLATES, AND WIRE HARNESS

(71) Applicant: Yazaki Corporation, Tokyo (JP)

(72) Inventors: Daisuke SUGIYAMA, Makinohara-shi (JP); Masanobu HIGASHITANI, Makinohara-shi (JP); Tomoaki HAYAKAWA, Makinohara-shi (JP); Yasukazu CHIKAMATSU, Makinohara-shi (JP)

(73) Assignee: Yazaki Corporation, Tokyo (JP)

(21) Appl. No.: 18/447,627

(22) Filed: Aug. 10, 2023

(30) Foreign Application Priority Data
Sep. 14, 2022 (JP) 2022-146217

(51) Int. Cl. H01R 13/42; B60R 16/02; H01R 13/03; H01R 13/502

(52) U.S. Cl. CPC H01R 13/42; B60R 16/0207; H01R 13/03; H01R 13/502; H01R 2201/26

(57) ABSTRACT

A fastening structure 100 of metal plates includes a first metal plate 2 including a first hole portion 2A, a second metal plate 3 including a second hole portion 3A, and a fastening material B1 fastened to penetrate the first hole portion and the second hole portion, with the first metal plate and the second metal plate overlapping each other, wherein the first metal plate is provided with protrusions 24, 24, the second metal plate is provided with receiving portions 31A, 31B in which the protrusions fit, and with the protrusions fitting in the receiving portions, the first metal plate is restricted from rotating with respect to the second metal plate.

### TECHNICAL FIELD

The present invention relates to a fastening structure of metal plates, a device connector including the fastening structure of the metal plates, and a wire harness.

### BACKGROUND

Conventionally, a connector for a device attached to a device housing of an electronic device mounted on a vehicle, such as, e.g., an inverter or a motor mounted on a hybrid vehicle or an electric vehicle, is known (for example, see Patent Document 1).

The connector for the device disclosed in Patent Document 1 includes electric wire-side terminals connected to ends of electric wires, device-side terminals connected to the device, connection terminals electrically connecting the electric wire-side terminals and the device-side terminals, and a housing accommodating these terminals. The electric wire-side terminal is inserted from the lower side to the upper side of the housing, and one end of the connection terminal overlaps and is fastened to the electric wire-side terminal, and the other end thereof is formed to extend toward the device body.

In such a conventional connector for a device, in order to fasten the electric wire-side terminal and the connection terminal, it used to be necessary to align the positions of the mounting holes of the electric wire-side terminals and the connection terminals, resulting in poor working efficiency. During fastening, the terminals may co-rotate due to the frictional force of the bolt seating surface, which may cause the terminals to tilt or the electric wires to twist.

As a countermeasure, it is conceivable to provide a pair of hole portions in the vicinity of the mounting hole at one end of the connection terminal and insert a jig into each of the hole portions. Specifically, in order to fasten the electric wire-side terminal and the connection terminal, with the jig being inserted into each of the hole portions of the connection terminal, the electric wire-side terminal is inserted into the housing and the electric wire-side terminal is abutted against the jig. Accordingly, the insertion point of the electric wire-side terminal is determined, and the mounting holes of the electric wire-side terminal and the connection terminal are aligned. In addition, during fastening, the edge of the electric wire-side terminal abuts against the jig, so that co-rotation of the electric wire-side terminal is restricted.

### RELATED ART

### Patent Document

[Patent Document 1] JP 2015-082466 A

### SUMMARY OF THE INVENTION

### Problem to be Solved by the Invention

However, with conventional connectors for devices, if a jig is used to fasten the electric wire-side terminal and the connection terminal, i.e., fasten the metal plates to each other with bolts, it is necessary to perform a task for attaching and detaching the jig, which reduces the work efficiency.

It is an object of the present invention to provide a fastening structure of metal plates, a device connector including the fastening structure of the metal plates, and a wire harness that improve the workability of assembly.

### Solution to Problem

In order to solve the problem and achieve the object, a fastening structure of metal plates according to the present invention includes a first metal plate including a first hole portion, a second metal plate including a second hole portion, and a fastening material fastened to penetrate the first hole portion and the second hole portion, with the first metal plate and the second metal plate overlapping each other, wherein the first metal plate is provided with a protrusion, the second metal plate is provided with a receiving portion in which the protrusion fits, and with the protrusion fitting in the receiving portion, the first metal plate is restricted from rotating with respect to the second metal plate.

### Advantageous Effects of the Invention

According to the present invention, the workability of assembly can be improved.

### BRIEF DESCRIPTION OF THE DRAWINGS

FIG. 1 is a perspective view illustrating a wire harness to which a fastening structure of metal plates according to one embodiment of the present invention is applied.

FIG. 2 is an exploded perspective view illustrating the wire harness.

FIG. 3A is a front view illustrating a device-side terminal (a first metal plate) constituting the fastening structure of metal plates. FIG. 3B is a side view of FIG. 3A.

FIG. 4 is a front view illustrating an electric wire-side terminal (a second metal plate) constituting the fastening structure of metal plates.

FIGS. 5A and 5B are views for explaining a procedure for assembling a wire harness to which the fastening structure of metal plates is applied. FIG. 5A is a front view illustrating a state in which the device-side terminal and the electric wire-side terminal are supported by the housing. FIG. 5B is an enlarged view illustrating an essential portion of FIG. 5A.

### DETAILED DESCRIPTION OF THE EXEMPLARY EMBODIMENT

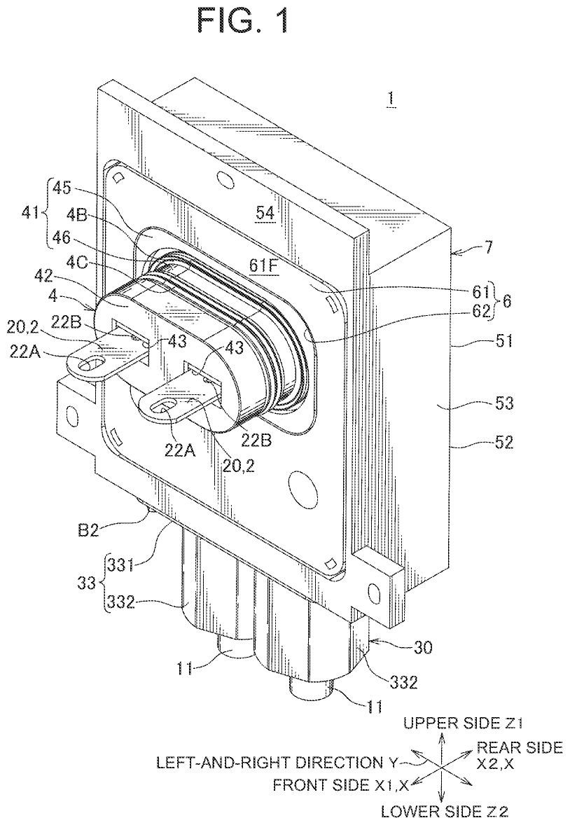

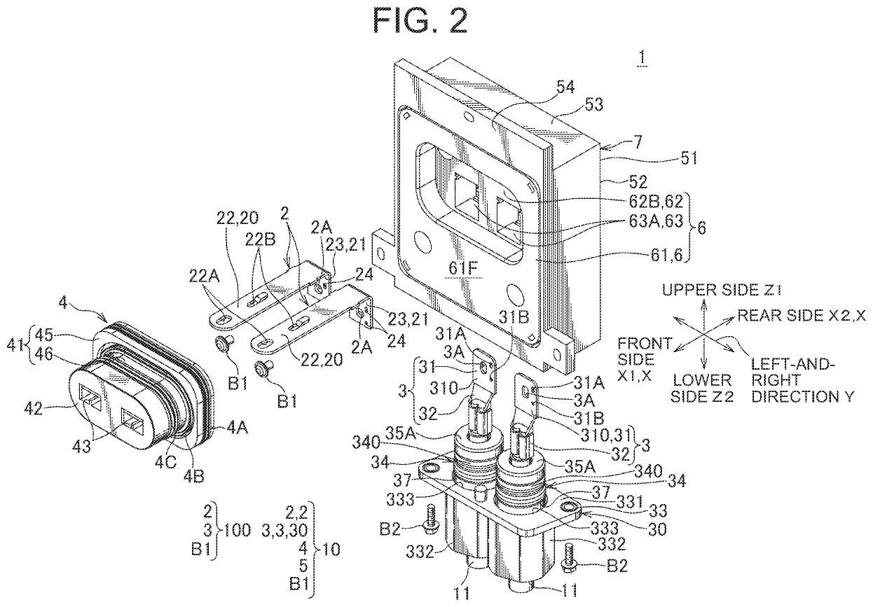

Hereinafter, one embodiment of the present invention will be described below with reference to FIGS. 1 to 5. FIG. 1 is a perspective view illustrating a wire harness 1 to which a fastening structure 100 of the metal plates according to one embodiment of the present invention is applied. FIG. 2 is an exploded perspective view illustrating the wire harness 1. As illustrated in FIGS. 1 and 2, the device connector 10 according to the present embodiment constitutes the wire harness 1 provided in an automobile and the like, and is configured to be able to fit with the case of a mating device, not illustrated (hereinafter referred to as a mating case).

As illustrated in FIGS. 1 and 2, the wire harness 1 includes: an L-shaped device connector 10 including device-side terminals 2 (first metal plates) and electric wire-side terminals 3 (second metal plates); and a pair of shielded electric wires 11 (wires) connected to the electric wire-side terminals 3 of the device connector 10 and extending from the device connector 10.

Hereinafter, a fitting direction in which the device connector 10 and the mating case fit each other may be referred to as a “front-and-rear direction X”, one of the directions perpendicular to the “front-and-rear direction X” may be referred to as a “left-and-right direction Y”, and the other of the directions perpendicular to the “front-and-rear direction X” may be referred to as an “up-and-down direction Z”. In the “front-and-rear direction X”, a direction closer to the mating case with reference to the device connector 10 may be referred to as a “front side X1”, and a direction opposite thereto may be referred to as a “rear side X2”.

As illustrated in FIGS. 1 and 2, the device connector 10 includes: a pair of device-side terminals 2, 2 in an L shape that fits the mating case; a device-side housing 4 configured to hold the pair of device-side terminals 2, 2; a straight connector 30 including a pair of electric wire-side terminals 3, 3; bolts B1 (fastening materials illustrated in FIG. 2) fastening the device-side terminal 2 and the electric wire-side terminal 3; and a housing portion 7 configured to support the device-side terminals 2 and the electric wire-side terminals 3.

As illustrated in FIG. 2, this device connector 10 is configured such that a direction in which the straight connector 30 is inserted into the housing portion 7 (up-and-down direction Z) and a direction in which the device-side terminal 2 fits into the mating case (front-and-rear direction X) are perpendicular to each other (cross each other).

Furthermore, as illustrated in FIG. 2, the fastening structure 100 of the metal plates is applied to the device connector 10. The fastening structure 100 of the metal plates includes: one of the device-side terminals 2 including the device-side bolt hole 2A (first hole portion); one of the electric wire-side terminals 3 including the electric wire-side bolt hole 3A (second hole portion); and one of the bolts B1 (fastening material) that penetrates the bolt holes 2A, 3A to fasten the device-side terminal 2 and the electric wire-side terminal 3. Furthermore, the fastening structure 100 of the metal plates is supported on the housing portion 7 in such a state that the bolt B1 penetrates the bolt holes 2A, 3A to fasten the device-side terminal 2 and the electric wire-side terminal 3.

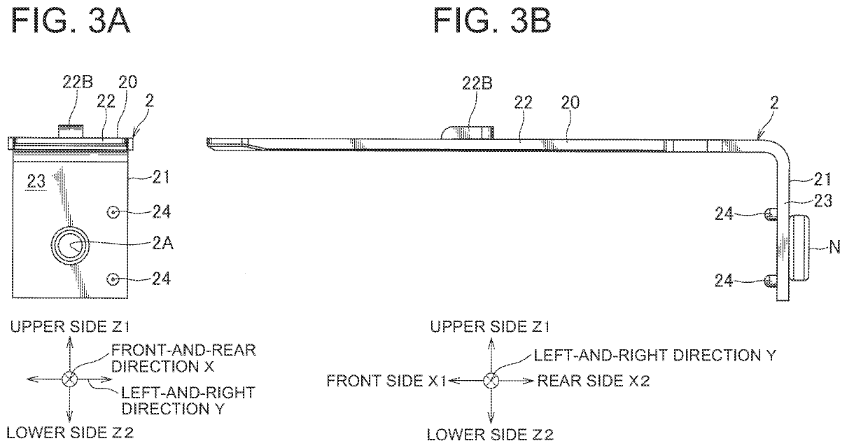

As illustrated in FIGS. 2, 3, each of the device-side terminals 2 is formed by pressing and bending a conductive sheet metal, and includes: a device-side fitting portion 20 formed into a rectangular plate shape to fit into the mating case; and a device-side fastening portion 21 continuous to the rear end of the device-side fitting portion 20 and supported by the housing portion 7. The device-side terminal 2 is formed in an L shape such that the border between the device-side fitting portion 20 and the device-side fastening portion 21 is bent.

As illustrated in FIGS. 2, 3, the device-side fitting portion 20 includes: a fitting-side body 22 extending in a flat plate shape in the front-and-rear direction X and the left-and-right direction Y; a fastening hole 22A (illustrated in FIG. 2) configured to be fastened to the mating case with the bolt; and a cut-and-raised portion 22B configured to engage the device-side housing 4 explained later. The fastening hole 22A is provided in the front end portion of the fitting-side body 22, and the cut-and-raised portion 22B is provided in the middle portion of the fitting-side body 22 in the front-and-rear direction X. The device-side fitting portion 20 is configured such that, with the cut-and-raised portion 22B engaging the device-side housing 4, the front side X1 of the cut-and-raised portion 22B is exposed.

As illustrated in FIGS. 2, 3, the device-side fastening portion 21 includes: a fixing-side body 23 extending in a flat plate shape in the up-and-down direction Z and the left-and-right direction Y; a device-side bolt hole 2A (illustrated in FIG. 2) in a circular shape into which the bolt B1 is inserted; a nut N (illustrated in FIG. 3A) fixed to the fixing-side body 23 in such a manner to be in communication with the device-side bolt hole 2A; and a pair of pin-shaped portions 24, 24 (a pair of protrusions) formed by stamping.

As illustrated in FIG. 3B, the device-side bolt hole 2A is provided in a central portion of the fixing-side body 23. As illustrated in FIG. 3A, on one side of the device-side bolt hole 2A in the left-and-right direction Y, the pin-shaped portions 24, 24 constituting the pair are arranged in the up-and-down direction Z with the device-side bolt hole 2A interposed therebetween. Each of the pin-shaped portions 24 is arranged to protrude to the front side X1 (toward the side opposite to the housing portion 7 with reference to the fixing-side body 23).

As illustrated in FIGS. 1 and 2, the device-side housing 4 includes: a device-side housing body 41; a front member 42 attached to a front end portion of the device-side housing body 41; a pair of device insertion holes 43, 43 penetrating the device-side housing body 41 and the front member 42 to allow the device-side fitting portion 20 of each of the device-side terminals 2 to pass through; and a rubber seal 4A (illustrated in FIG. 2), 4B, and 4C.

As illustrated in FIG. 2, the device-side housing body 41 includes: a device-side installation portion 45 formed in a rounded rectangular plate shape and configured to be placed in the housing portion 7 explained later; and a mating insertion portion 46 provided continuously to the front side X1 of the device-side installation portion 45 and configured to be inserted into the opening portion of the mating case. The mating insertion portion 46 is formed to have a pillar shape with an elliptic shape in the front view. The front member 42 is attached to the front end portion of the mating insertion portion 46.

As illustrated in FIG. 2, the rubber seal 4A is fitted on the outer peripheral portion of the device-side installation portion 45, such that the rubber seal 4A is configured to be interposed between the device-side installation portion 45 and an installation recessed portion 62 of the housing portion 7 explained later. As illustrated in FIGS. 1 and 2, the rubber seal 4B is fitted on a base portion of the mating insertion portion 46 close to the device-side installation portion 45, such that the rubber seal 4B is configured to be interposed between the mating insertion portion 46 and the opening portion of the mating case when the device connector 10 and the mating case fit each other. As illustrated in FIGS. 1 and 2, the rubber seal 4C is attached to the border portion between a counter-attachment portion and the front member 42.

As illustrated in FIG. 2, the straight connector 30 includes: a pair of electric wire-side terminals 3, 3, each being connected to an end portion of a corresponding one of shielded electric wires 11, 11 constituting a pair; an electric wire holding member 33 configured to hold the pair of shielded electric wires 11, 11; and shield bodies 34, 34 sheathing the respective shielded electric wires 11, 11.

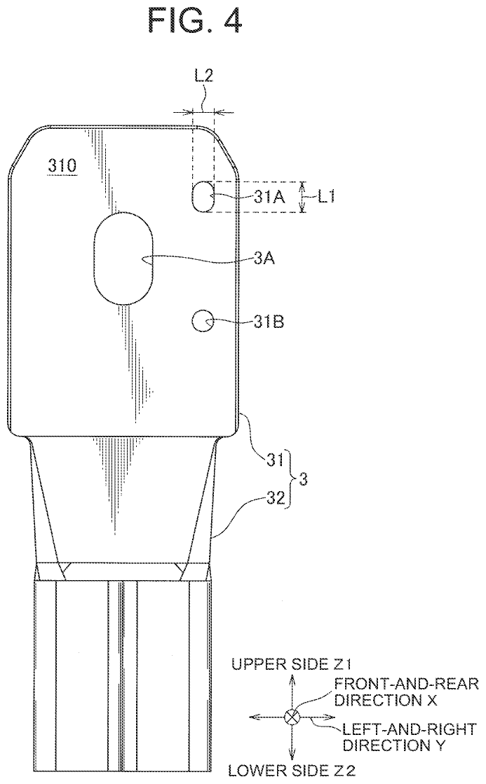

As illustrated in FIG. 4, each of the electric wire-side terminals 3 is formed by pressing and bending a conductive sheet metal, and includes: an electric wire-side fastening portion 31 overlapping and being fastened to the device-side fastening portion 21 of the device-side terminal 2; and an electric wire crimp portion 32 (wire connection portion) crimped to the shielded electric wire 11.

As illustrated in FIG. 4, the electric wire-side fastening portion 31 includes: a terminal body 310 extending in a flat plate shape in the up-and-down direction Z and the left-and-right direction Y; an electric wire-side bolt hole 3A into which the bolt B1 is inserted; and a pair of positioning holes 31A, 31B (a pair of receiving portions) configured to respectively fit on the pair of pin-shaped portions 24, 24 of the device-side terminal 2.

As illustrated in FIG. 4, the electric wire-side bolt hole 3A is provided in the central portion of the terminal body 310. This electric wire-side bolt hole 3A is formed such that the size in the up-and-down direction Z is slightly larger than the size in the left-and-right direction Y.

As illustrated in FIG. 4, on one side of the electric wire-side bolt hole 3A in the left-and-right direction Y, the positioning holes 31A, 31B constituting the pair are arranged in the up-and-down direction Z with the electric wire-side bolt hole 3A interposed therebetween. Specifically, the positioning holes 31A, 31B constituting the pair are arranged in the same direction as the direction in which the shielded electric wire 11 extends (up-and-down direction Z). In the present embodiment, each of the positioning holes 31A, 31B is constituted by a through hole penetrating the terminal body 310.

As illustrated in FIG. 4, the positioning holes 31A that is one of the positioning holes 31A, 31B constituting the pair is formed as an elongated hole a size L1 of which in the up-and-down direction Z (a size in a direction in which the receiving portions constituting the pair are arranged) is greater than a size L2 in the left-and-right direction Y (a size in a direction perpendicular to the arrangement direction). The positioning holes 31B that is the other of the positioning holes 31A, 31B constituting the pair is formed in a circular shape. In this manner, the positioning holes 31A that is one of the positioning holes 31A, 31B constituting the pair is formed as the elongated hole, so that variation in the size of the pin-shaped portions 24, 24 formed in the device-side terminal 2 is absorbed, and the pair of pin-shaped portions 24, 24 can be respectively fitted into the pair of positioning holes 31A, 31B.

As illustrated in FIG. 2, the electric wire holding member 33 includes: a flange portion 331 formed in a rounded rectangular plate shape and fastened to the housing portion 7, explained later, with the bolt B2; a pair of cylindrical portions 332, 332 formed to extend to the lower side Z2 of the flange portion 331; and a pair of electric wire insertion holes 333, 333 penetrating the flange portion 331 to allow the respective shielded electric wires 11 to pass through.

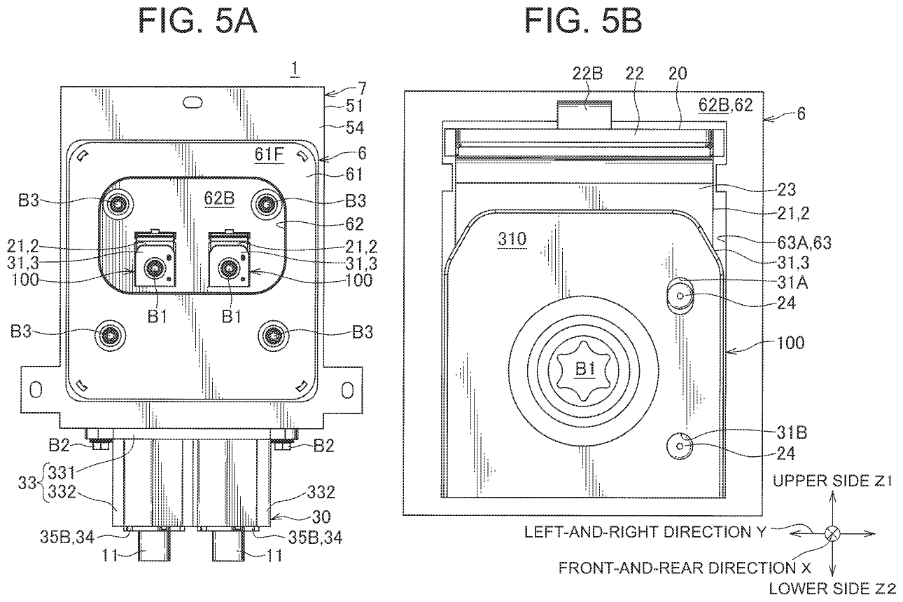

As illustrated in FIGS. 2, 5A, and 5B, each of the shield bodies 34 includes: a shield member 340 (illustrated in FIG. 2) in a cylindrical shape configured to electrically connect a braided conductor (not illustrated) of the shielded electric wire 11 and a shell member 51 of the housing portion 7 explained later; a pair of support members 35A (illustrated in FIG. 2) and 35B (illustrated in FIG. 5A) configured to support the shield member 340 with the shield member 340 interposed therebetween in the up-and-down direction Z (a direction in which the shielded electric wire 11 extends); and a seal member 37 (illustrated in FIG. 2) in a cylindrical shape interposed between the electric wire insertion hole 333 and the shielded electric wire 11.

As illustrated in FIG. 2, the straight connector 30 is configured such that, with each of the shield members 340 being electrically connected to the braided conductor of the corresponding one of the shielded electric wires 11, the shield member 340 is electrically connected to the shell member 51 of the housing portion 7 explained later. As a result, a shield circuit is formed that shields electrical noise leaking from the shielded electric wires 11 that transmit control signals and the like, or electrical noise coming in from the outside.

As illustrated in FIGS. 1, 2, 5A, and 5B, the housing portion 7 includes: a shell member 51 made of metal; a housing member 6 (housing) made of synthetic resin and accommodated in the shell member 51; first insertion holes (not illustrated) which are provided in the shell member 51 and into which the electric wire-side terminals 3 are inserted; and second insertion holes (not illustrated) provided in the housing member 6 to be in communication with the upper side Z1 of the first insertion holes.

Furthermore, in the housing portion 7, the electric wire-side terminals 3 are inserted into the first insertion holes and the second insertion holes, with the housing member 6 being accommodated in the shell member 51. With the electric wire-side terminals 3 being inserted into the first insertion hole and the second insertion hole, the pair of shielded electric wires 11, 11 extend from the housing portion 7 to the lower side Z2.

As illustrated in FIGS. 1 and 2, the shell member 51 includes: a wall portion 52 in a rectangular plate shape; a surrounding wall 53 erected from the peripheral edge of the wall portion 52 toward the front side X1; and a facing wall portion 54 continuous to the front end of the surrounding wall 53 and facing the mating case, and is configured to be open on the front side X1. Furthermore, the shell member 51 is provided with first insertion holes penetrating the surrounding wall 53 in the up-and-down direction Z.

As illustrated in FIG. 2, the housing member 6 includes: a container body 61 in a cubic shape accommodated in the shell member 51; an installation recessed portion 62 which is formed in a front surface 61F of the container body 61 and in which the device-side installation portion 45 of the device-side housing 4 is installed; and a pair of support recessed portions 63, 63 formed by cutting a bottom surface 62B of the installation recessed portion 62 and configured to support the terminals 2, 3.

The container body 61 is provided with the second insertion holes extending in the up-and-down direction Z. The second insertion holes are located on the upper side Z1 of the first insertion holes of the shell member 51, and are configured to open through peripheral surfaces 63A of the respective support recessed portion 63.

As illustrated in FIG. 2, the support recessed portion 63 includes: a peripheral surface 63A continuous to the bottom surface 62B of the installation recessed portion 62; and an installation surface (not illustrated) which is continuous to the peripheral surface 63A and in which the device-side fastening portion 21 of the device-side terminal 2 is installed.

As illustrated in FIGS. 2, 5A, and 5B, assembly of the housing portion 7 includes placing the housing member 6 in the shell member 51 and fastening the shell member 51 and the housing member 6 with the bolt B3, thereby assembling the housing portion 7. In FIG. 2, the bolt B3 is omitted. With the housing portion 7 being assembled, the first insertion holes and the corresponding second insertion holes are in communication with each other.

Next, the procedure of assembling the wire harness 1 is explained with reference to FIGS. 2, 5A, and 5B. As illustrated in FIG. 2, the device-side housing 4, the housing portion 7, and the straight connector 30 are assembled in advance.

As illustrated in FIG. 2, the device-side fastening portions 21 of the device-side terminals 2 are brought (moved) closer to the respective support recessed portions 63 of the housing portion 7, in such a manner that the device-side fastening portions 21 are located on the lower side Z2 and on the rear side X2 of the respective device-side fitting portions 20. As the movement progresses, the device-side fastening portions 21 are installed on the installation surfaces of the support recessed portions 63 of the housing portion 7.

Thereafter, as illustrated in FIGS. 5A and 5B, the electric wire-side terminals 3 of the straight connector 30 are brought closer to the housing portion 7, and the electric wire-side terminals 3 are inserted into the respective first insertion holes and the respective second insertion holes of the housing portion 7. As the insertion progresses, the electric wire-side fastening portions 31 of the electric wire-side terminals 3 move closer to the device-side fastening portions 21 of the device-side terminals 2, and the electric wire-side fastening portions 31 and the device-side fastening portions 21 face each other, so that the pair of positioning holes 31A, 31B formed in the electric wire-side fastening portions 31 approach and fit on the pair of pin-shaped portions 24, 24 formed on the device-side fastening portions 21. As a result, the insertion positions of the electric wire-side terminals 3 are determined.

With the pair of positioning holes 31A, 31B being respectively fit on the pair of pin-shaped portions 24, 24, the device-side bolt holes 2A of the device-side fastening portions 21 and the electric wire-side bolt holes 3A of the electric wire-side fastening portions 31 are in communication with each other, so that the bolts B1 are insertable. Furthermore, with the pair of positioning holes 31A, 31B formed in the electric wire-side fastening portions 31 being respectively fit on the pair of pin-shaped portions 24, 24 formed on the device-side fastening portions 21, co-rotating during fastening is restricted.

Thereafter, the bolts B1 are inserted into the device-side bolt holes 2A of the device-side fastening portions 21 and the electric wire-side bolt holes 3A of the electric wire-side fastening portions 31 and fastened to the nuts N. Accordingly, the device-side fastening portions 21 and the electric wire-side fastening portions 31 are fastened with the bolts B1, and the device-side fastening portions 21 and the electric wire-side fastening portions 31 are supported on the respective support recessed portions 63.

Thereafter, as illustrated in FIGS. 5A and 5B, with the flange portion 331 of the straight connector 30 overlapping the surrounding wall 53 of the shell member 51, the flange portion 331 and the surrounding wall 53 of the shell member 51 are fastened with the bolts B2. As a result, the braided conductor of the shielded electric wires 11, the shield members 340, and the shell member 51 are electrically connected, and the shield circuit is formed. In this manner, the straight connector 30 is fixed to the housing portion 7.

Finally, the ends of the device-side terminals 2 are brought closer to and inserted into the pair of device insertion holes 43, 43 of the device-side housing 4. As the insertion progresses, the cut-and-raised portions 22B of the device-side terminals 2 engage the device-side housing 4, so that the pair of device-side terminals 2, 2 is held by the device-side housing 4. In this manner, assembly of the wire harness 1 including the device connector 10 is completed.

According to the above-described embodiment, the device-side terminal 2 (first metal plate) including the device-side bolt hole 2A (first hole portion); the electric wire-side terminal 3 (second metal plate) including the electric wire-side bolt hole 3A (second hole portion); and the bolt B1 (fastening material) penetrating the device-side bolt hole 2A and the electric wire-side bolt hole 3A, with the device-side terminal 2 and the electric wire-side terminal 3 overlapping each other are provided. The device-side terminal 2 is provided with the pin-shaped portions 24 (protrusions), and the electric wire-side terminal 3 is provided with the positioning holes 31A, 31B (receiving portion) in which the pin-shaped portions 24 fit. With the pair of pin-shaped portions 24, 24 being fit into the positioning holes 31A, 31B, the bolt holes 2A, 3A of the device-side terminal 2 and the electric wire-side terminal 3 can be aligned without using a jig, and co-rotation of the electric wire-side terminal 3 during fastening of the bolt can be restricted. As a result, the step of attaching and detaching the jig can be omitted, and the workability of assembly can be improved.

Furthermore, the pair of pin-shaped portions 24 (protrusions) is provided, the pair of positioning holes 31A, 31B (receiving portions) is provided, and the pair of positioning holes 31A, 31B is configured to be respectively fit on the pair of pin-shaped portions 24, 24. According to this configuration, with the pair of positioning holes 31A, 31B being respectively fit on the pair of pin-shaped portions 24, 24, co-rotation of the electric wire-side terminal 3 (second metal plate) during fastening of the bolt can be more fully restricted.

Furthermore, one positioning hole (positioning hole 31A) of the positioning holes 31A, 31B (receiving portions) constituting the pair is formed to be greater in the size L1 in the up-and-down direction Z (size in a direction in which the receiving portions constituting the pair are arranged) than in the size L2 in the left-and-right direction Y (size in the direction perpendicular to the direction in which the receiving portions constituting the pair are arranged). According to this configuration, variation in the size of the pin-shaped portions 24, 24 formed in the device-side terminal 2 is absorbed, and it is easier to respectively fit the pair of pin-shaped portions 24, 24 into the pair of positioning holes 31A, 31B.

It should be noted that the present invention is not limited to the above embodiment, but includes other configurations and the like that can achieve the purpose of the present invention, and the following modifications are also included in the present invention.

Although, in the above-described embodiment, the pair of positioning holes 31A, 31B (receiving portions) is constituted by through-holes passing through the electric wire-side terminals 3 (second metal plates), the present invention is not limited thereto. The receiving portion may be constituted by a pair of recessed portions into which the pair of pin-shaped portions 24, 24 of the device-side terminal 2 fits.

Furthermore, although the device connector 10 to which the fastening structure 100 of the metal plates according to the above-described embodiment is applied includes the pair of pin-shaped portions 24, 24 (protrusions) and the pair of positioning holes 31A, 31B (receiving portions) into which the pair of pin-shaped portions 24, 24 fit, the present invention is not limited thereto. The receiving portions may be constituted by a single elongated hole or a single recessed portion continuous in the up-and-down direction Z.

Furthermore, although, in the above-described embodiment, the pair of pin-shaped portions 24, 24 (protrusions) and the pair of positioning holes 31A, 31B (receiving portions) are arranged in the direction in which the electric wire-side terminal 3 is inserted (up-and-down direction Z), the present invention is not limited thereto. The pair of protrusions and the pair of receiving portions may be arranged in the left-and-right direction Y, or may be arranged on both sides of each of the bolt holes 2A, 3A.

Furthermore, although, in the above-described embodiment, the device-side terminals 2 (first metal plates) are formed in an L shape, the present invention is not limited thereto. The device-side fitting portion 20 constituting the device-side terminal 2 may extend in the same plane as the device-side fastening portion 21, or the device-side fitting portion 20 and the device-side fastening portion 21 may extend in two directions that cross each other. Furthermore, the device connector may be configured such that the direction in which the straight connector 30 is inserted into the housing portion 7 (up-and-down direction Z) and the direction in which the device-side terminal 2 engages the mating case (front-and-rear direction X) are the same direction, or are directions that cross each other.

Furthermore, although, in the above-described embodiment, with the device-side terminal 2 (first metal plate) and the electric wire-side terminal 3 (second metal plate) overlapping each other, the bolt B1 (fastening material) is fastened to the nut N by penetrating the device-side bolt hole 2A (first hole portion) and the electric wire-side bolt hole 3A (second hole portion), the present invention is not limited thereto. The nut N may be embedded in the installation surface of each of the support recessed portions 63 of the housing member 6 and fastened to the bolt B1, or female threads may be cut on the installation surface of the housing member 6 to be fastened to the bolt B1.

Furthermore, although, in the above-described embodiment, the fastening structure 100 of the metal plates is applied to the device connector 10, the present invention is not limited thereto. The fastening structure of metal plates may be applied to a terminal block, or may be applied to an electric junction box.

Furthermore, although, in the above-described embodiment, the wire harness 1 includes the pair of shielded electric wires 11, the present invention is not limited thereto. The wire harness may include at least one covered electric wire. In that case, the shell member 51 may be omitted. That is, the housing only needs to include the housing member 6.

Although the best configuration, method, and the like for carrying out the present invention are disclosed in the above description, the present invention is not limited thereto. That is, although the present invention has been particularly illustrated and described primarily with respect to the particular embodiment, it is understood that, without departing from the spirit and scope of the present invention, the present invention can be modified in various ways by those skilled in the art in terms of shape, material, quantity, and other detailed configurations of the embodiment described above. Therefore, since the descriptions that limit the shape, material, and the like disclosed above are illustrative examples to facilitate understanding of the present invention, and do not limit the present invention, a description with a name of a member, from which some or all of the limitations on the shape, material, and the like are deleted, is to be included in the present invention.

### LIST OF REFERENCE SIGNS

1 wire harness
10 device connector
100 fastening structure of metal plates
2 device-side terminal (first metal plate)
2A device-side bolt hole (first hole portion)
20 device-side fitting portion
21 device-side fastening portion
24, 24 pair of pin-shaped portions (protrusion)
3 wire-side terminal (second metal plate)
3A wire-side bolt hole (second hole portion)
31 wire-side fastening portion
31A, 31B pair of positioning holes (receiving portion)
32 wire crimp portion (wire connection portion)
6 housing member (housing)
11 shielded electric wire (wire)
B1 bolt (fastening material)
L1 size in up-and-down direction (size in a direction in which a pair of receiving portions is arranged)
L2 size in left-and-right direction (size in a direction perpendicular to the arrangement direction)

What is claimed is:

1. A fastening structure of metal plates, comprising:
a first metal plate including a first hole portion;
a second metal plate including a second hole portion; and
a fastening material fastened to penetrate the first hole portion and the second hole portion, with the first metal plate and the second metal plate overlapping each other,
wherein the first metal plate is provided with a protrusion,
the second metal plate is provided with a receiving portion in which the protrusion fits, and
with the protrusion fitting in the receiving portion, the first metal plate is restricted from rotating with respect to the second metal plate.

2. The fastening structure of the metal plates according to claim 1,
wherein the protrusion comprises a pair of protrusions,
the receiving portion comprises a pair of receiving portions, and
the pair of receiving portions is configured to respectively fit on the pair of protrusions.

3. The fastening structure of the metal plates according to claim 2, wherein one of the receiving portions constituting the pair is greater in size in a direction in which the receiving portions constituting the pair are arranged than in a direction perpendicular to the direction in which the receiving portions constituting the pair are arranged.

4. A device connector connected to a mating device, the device connector comprising the fastening structure of the metal plates according to claim 1,
wherein the first metal plate constitutes a device-side terminal engaging the mating device,
the second metal plate constitutes an electric wire-side terminal connected to an electric wire,
the device connector comprises a housing configured to support the device-side terminal and the electric wire-side terminal, with the device-side terminal and the electric wire-side terminal being fastened by the fastening material,
the device-side terminal includes a device-side fitting portion configured to engage the mating device and a device-side fastening portion, and is formed to be bent at a border between the device-side fitting portion and the device-side fastening portion,
the first hole portion and the protrusion are formed on the device-side fastening portion,
the electric wire-side terminal includes an electric wire connection portion connected to the electric wire and an electric wire-side fastening portion, and
the second hole portion and the receiving portion are provided on the electric wire-side fastening portion.

5. A wire harness comprising:
the device connector according to claim 4; and
an electric wire connected to the electric wire-side terminal and extending from the device connector.
